(19) United States
(12) Patent Application Publication
(10) Pub. No.: US 2007/0120627 A1
(43) Pub. Date: May 31, 2007

(54) Bandpass filter with multiple attenuation poles

(76) Inventor: Arun Chandra Kundu, Phoenix, AZ (US)

Correspondence Address: SQUIRE SANDERS & DEMPSEY LLP, TWO RENAISSANCE SQUARE, 40 NORTH CENTRAL AVENUE, SUITE 2700, PHOENIX, AZ, 85004-4498, US

(21) Appl. No.: 11/288,674

(22) Filed: Nov. 28, 2005

(51) Int. Cl. H01P 1/205; H01P 1/203

(52) U.S. Cl. 333/203; 333/204

(57) ABSTRACT

A bandpass filter includes a combline bandpass filter including tapped-line input and output terminals, at least three resonators, and a loading capacitor for each resonator. The bandpass filter further includes a plurality of loading inductors, each loading inductor being connected between one of the resonators and its respective loading capacitor; and a direct coupling capacitor connected between any two of the at least three resonators that are separated by at least one other resonator. By adding a direct coupling capacitor to a combline bandpass filter, an additional lower-passband side attenuation pole is created. The attenuation and rolloff characteristics of the lower-passband side can be controlled by altering the value of the direct coupling capacitance. By adding loading inductors to a combline bandpass filter, an upper-passband side attenuation pole is created. The attenuation and rolloff characteristics of the upper-passband side can be controlled by altering the value of the loading inductors.

### DESCRIPTION OF THE INVENTION

### Field of the Invention

The present invention relates to a bandpass filter, and more specifically to a bandpass filter having multiple attenuation poles.

### BACKGROUND OF THE INVENTION

In recent years, marked advances in the miniaturization of mobile communication terminals, such as mobile phones and Wireless LAN (Local Area Network) routers, has been achieved due to the miniaturization of the various components incorporated therein. One of the most important components incorporated in a communication terminal is the filter.

One type of bandpass filter used in such communication applications is disclosed in U.S. Pat. No. 6,424,236 (Kato) and is shown in FIG. 1A. FIG. 1A depicts a bandpass filter utilizing three inductor-capacitor (LC) resonators. The filter further includes three inductors, three capacitors, two input/output (I/O) capacitors, two coupling capacitors and a pole adjustment pattern 47 facing the coupling capacitor pattern.

As seen in FIG. 1B, by changing the size of pole adjustment pattern 47, the position of poles at the lower attenuations band is adjusted. For example, when the area of the overlapping portion between the coupling capacitors patterns and pole adjustment pattern is increased, an electrostatic capacitor generated between them is increased, which increases the spacing between poles. By changing the size of pole adjustment pattern 47, the distance between the two poles are controlled. However, as a result, when the attenuation closer to the lower-passband side of the frequency band is improved, the very low frequency band attenuation is deteriorated. In addition, while altering pole adjustment pattern 47 controls the distance between the lower-passband side poles, it does not allow for individual control of the poles.

While the Kato bandpass filter is generally acceptable for the creation of an additional attenuation pole at the lower-passband side of the filter, the requirement for I/O capacitors increases the size of the filter and makes it less suitable for application in smaller communication devices. For wide band filters, the size of these capacitors should be big enough to provide required external circuit coupling. Such capacitors can increase the size and cost of the filter. In addition, the Kato filter lacks the ability to individually control the lower-passband side attenuation poles and completely lacks an upper-passband side attenuation pole.

### SUMMARY OF THE INVENTION

The invention provides a bandpass filter having multiple attenuation poles.

According to one embodiment of the invention, the bandpass filter includes a combline bandpass filter including tapped-line input and output terminals, at least three resonators, and a loading capacitor for each resonator. The bandpass filter further includes a plurality of loading inductors, each loading inductor being connected between one of the resonators and its respective loading capacitor; and a direct coupling capacitor connected between any two of the at least three resonators that are separated by at least one other resonator.

Reduced size of the filter is achieved by using tapped-line input and output terminals rather than I/O capacitors typically found on conventional combline filters. By adding a direct coupling capacitor to a combline bandpass filter, an additional lower-passband side attenuation pole is created. The attenuation and rolloff characteristics of the lower-passband side can be controlled by altering the value of the direct coupling capacitance. By adding loading inductors to a combline bandpass filter, an upper-passband side attenuation pole is created. The attenuation and rolloff characteristics of the upper-passband side can be controlled by altering the value of the loading inductors.

According to another embodiment of the invention, the bandpass filter includes a combline bandpass filter including tapped-line input and output terminals, at least three resonators, and a loading capacitor for each resonator. The bandpass filter further includes a direct coupling capacitor connected between any two of the at least three resonators that are separated by at least one other resonator.

According to another embodiment of the invention, the bandpass filter includes a combline bandpass filter including tapped-line input and output terminals, at least three resonators, and a loading capacitor for each resonator. The bandpass filter further includes a direct coupling capacitor connected between any two of the at least three resonators that are separated by at least one other resonator. This bandpass filter adds an attenuation pole at the lower-passband side to the frequency response of the combline filter.

The frequency response of each of the embodiments described above can further be altered by adjusting the location of the tapped-line input and output terminals. Typically, the tapped-line input and output terminals are connected to the open end of the resonators. Out-of-band attenuation at both the lower- and upper-passband sides of the frequency response can be further improved by moving the location of the I/O terminals to some point below the open end of the resonators.

It is to be understood that the descriptions of this invention herein are exemplary and explanatory only and are not restrictive of the invention as claimed.

### BRIEF DESCRIPTION OF THE DRAWINGS

FIG. 1A depicts the physical layout of a prior art bandpass filter.

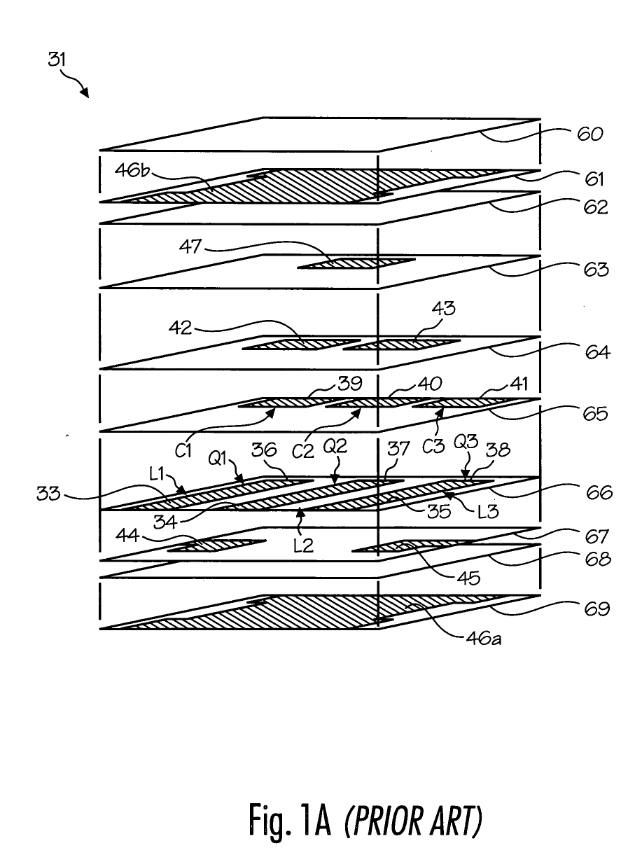

FIG. 1B depicts the frequency response of the prior art bandpass filter shown in FIG. 1.

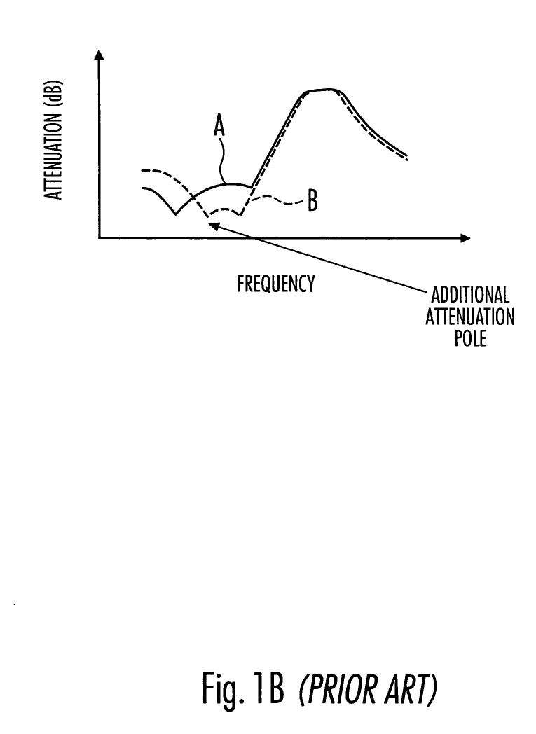

FIG. 2A depicts the schematic of a conventional combline bandpass filter.

FIG. 2B depicts the frequency response of a conventional combline bandpass filter.

FIG. 3 depicts the schematic of a bandpass filter having loading inductors and a direct coupling capacitor according to one embodiment of the invention.

FIG. 4 depicts the physical layout of a bandpass filter having loading inductors and a direct coupling capacitor according to one embodiment of the invention.

FIG. 5 depicts the frequency response of a bandpass filter having loading inductors and a direct coupling capacitor according to one embodiment of the invention.

FIG. 6 depicts the frequency response, in relation to direct coupling capacitance, of a bandpass filter having loading inductors and a direct coupling capacitor according to one embodiment of the invention.

FIG. 7 depicts the frequency response, in relation to loading inductance, of a bandpass filter having loading inductors and a direct coupling capacitor according to one embodiment of the invention.

FIG. 8 depicts a schematic of a bandpass filter having lowered I/O terminals according to one embodiment of the invention.

FIG. 9 depicts the physical layout of a bandpass filter having lowered I/O terminals according to one embodiment of the invention.

FIG. 10 depicts the frequency response, in relation to I/O terminal location, of a bandpass filter according to one embodiment of the invention.

FIG. 11 depicts a schematic of a bandpass filter having four resonators according to one embodiment of the invention.

FIG. 12 depicts a schematic of a bandpass filter having a direct coupling capacitor according to one embodiment of the invention.

FIG. 13 depicts the physical layout of a bandpass filter having a direct coupling capacitor according to one embodiment of the invention.

FIG. 14 depicts the frequency response of a bandpass filter having a direct coupling capacitor according to one embodiment of the invention.

FIG. 15 depicts a schematic of a bandpass filter having loading inductors according to one embodiment of the invention.

FIG. 16 depicts a physical layout of a bandpass filter having loading inductors according to one embodiment of the invention.

FIG. 17 depicts a frequency response of a bandpass filter having loading inductors according to one embodiment of the invention.

### DESCRIPTION OF THE EMBODIMENTS

Reference will now be made in detail to the present exemplary embodiments of the invention, examples of which are illustrated in the accompanying drawings.

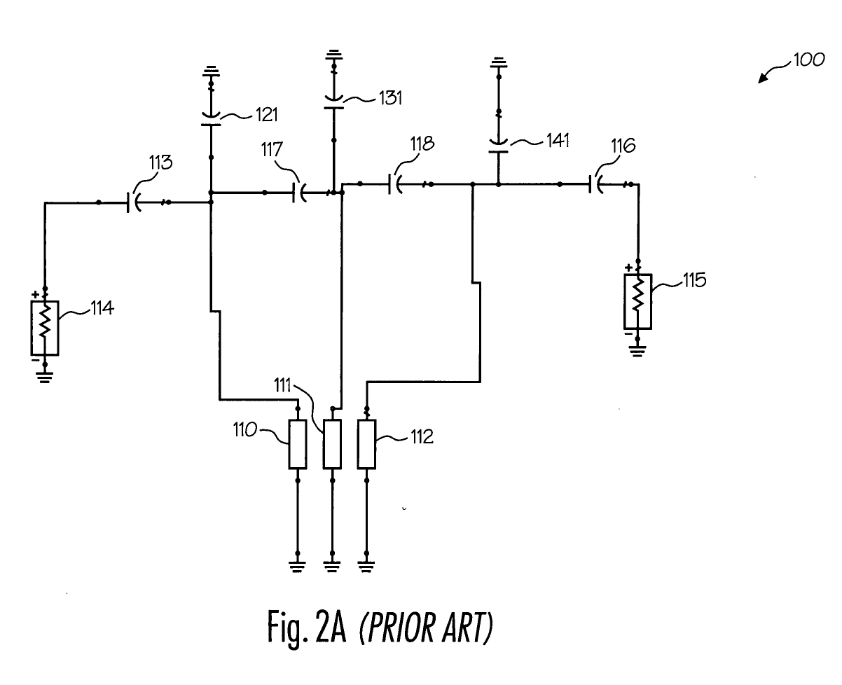

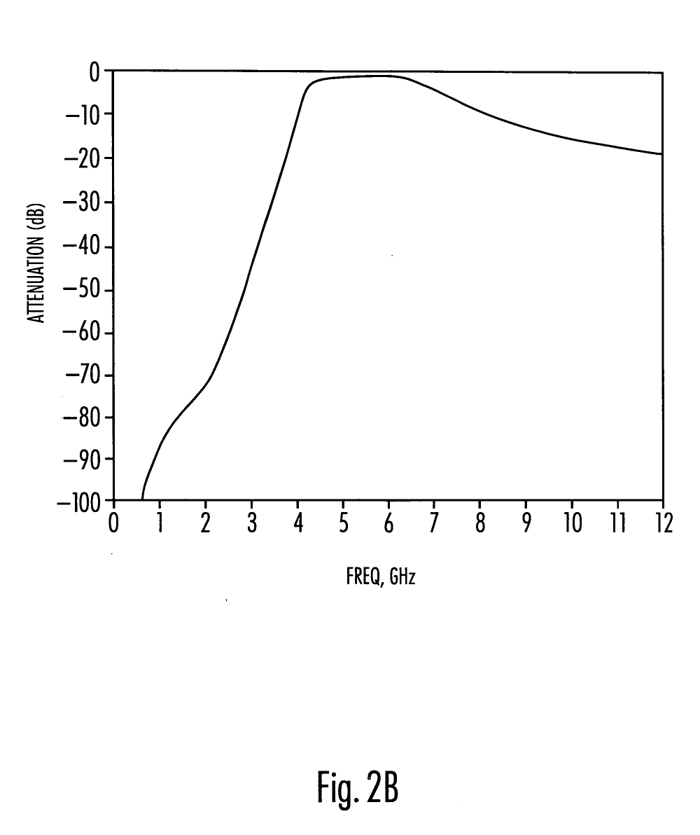

The present invention utilizes and modifies a conventional combline bandpass filter to create a new bandpass filter that exhibits multiple attenuation poles. FIG. 2A depicts the schematic of a conventional combline bandpass filter. Combline bandpass filter 100 includes three resonators 110, 111, and 112. Typically, the resonators are transverse electromagnetic (TEM) quarter-wave resonators. The short end of each of the resonators is connected to ground, while the open end of each of the resonators is connected to loading capacitors 121, 131 and 141, respectively. Internal coupling capacitor 117 connects the open end of first resonator 110 to the open end of second resonator 111. Internal coupling capacitor 118 connects the open end of second resonator 111 to the open end of third resonator 112. Input terminal 114 and input capacitor 113 are connected to the open end of first resonator 110, while output terminal 115 and output capacitor 116 are connected to the open end of third resonator 112.

FIG. 2B depicts the frequency response of the combline bandpass filter shown in FIG. 2A. As shown in FIG. 2B, a conventional combline bandpass filter has only one attenuation pole at the lower-passband side. There is no pole at the upper-passband side and the rolloff is relatively shallow.

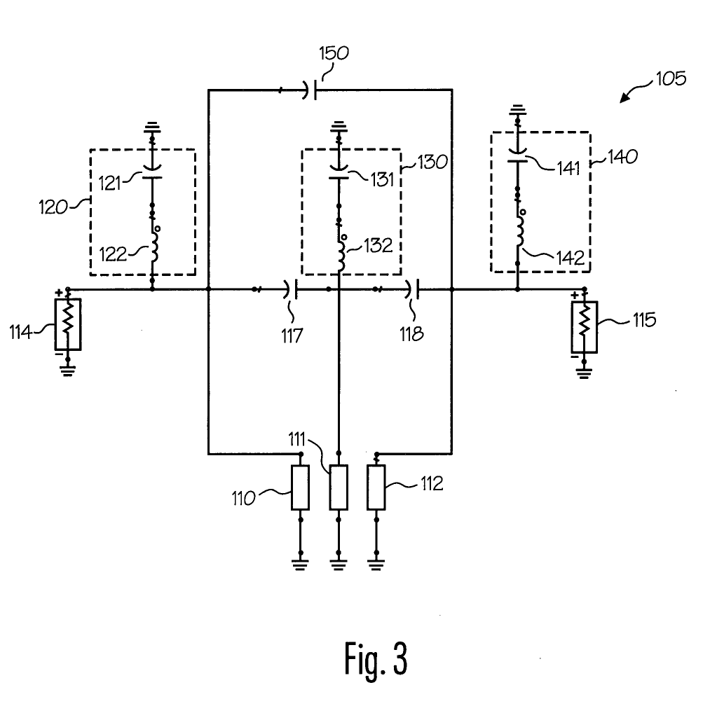

FIG. 3 depicts the schematic of bandpass filter 105 according to one embodiment of the invention. As can be seen in the schematic, bandpass filter 105 resembles combline bandpass filter 100 of FIG. 2A. However, in addition to the components of a conventional combline bandpass filter, bandpass filter 105 includes a direct coupling capacitor 150 and loading inductors 121, 131, and 141. In addition, bandpass filter 105 may operate without input and output capacitors. As shown in FIG. 3, input terminal 114 and output terminal 115 are tapped-line I/O terminals. That is, the input and output terminals connect directly to the resonators. In this way, space in the filter package may be saved.

The short end of first resonator 110, second resonator 111, and third resonator 112 are each connected to ground. The open end of the first, second, and third resonators is connected in series with a first LC pair 120, a second LC pair 130, and a third LC pair 140, respectively. The open end of first resonator 110 is connected to the open end of second resonator 111 by internal coupling capacitor 117, and likewise, the open end of second resonator 111 is connected to the open end of third resonator 113 by internal coupling capacitor 118. Direct coupling capacitor 150 connects the open end of first resonator 110 to the open end of third resonator 112. In addition, input terminal 114 is connected to the open end of first resonator 110 and output terminal 115 is connected to the open end of third resonator 113. Each of resonators 110, 111, and 112 are preferably transverse electromagnetic quarter-wave resonators.

First LC pair 120 consists of a first loading capacitor 121 and a first loading inductor 122. Likewise, second LC pair 130 consists of a second loading capacitor 131 and a second loading inductor 132, and third LC pair 140 consists of a third loading capacitor 141 and a third loading inductor 142. The LC pairs are connected between the open end of their respective resonators and ground. As shown in FIG. 3, the loading capacitors are directly connected to ground while the loading inductors are directly connected to a resonator, however this orientation may be reversed.

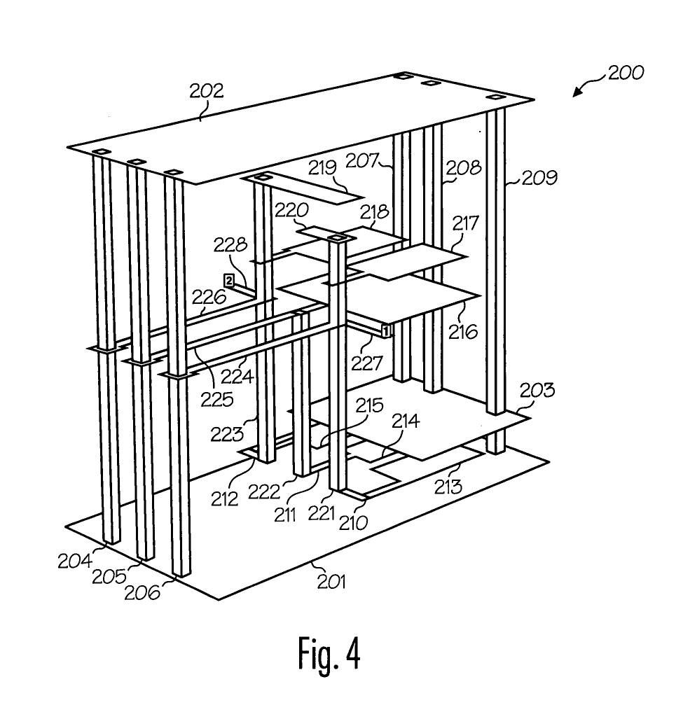

FIG. 4 depicts one example of a physical layout for the circuit shown in FIG. 3. Typically, for application in communication system and wireless LAN's, a multilayer structure would be employed. Preferably, the filter is created utilizing a low temperature co-fired ceramic (LTCC process), however any process for creating the multilayer structure may be employed, including thin-film processes, liquid crystal polymer processes, and other cell material technologies. In the description of FIG. 4 below, each of the metal regions may be formed from any suitable conductive material and is preferably, silver, copper, or gold. Likewise, all of the vias described below may be formed from any suitable conductive material, and are preferably formed from a conductive paste containing silver, copper, or gold.

As shown in FIG. 4, bandpass filter layout 200 includes metal regions 201, 202, and 203 form the system ground, first floating ground and second floating ground, respectively. The ground metal regions are connected to each other by vias 204, 205, 206, 207, 208, and 209. Metal regions 224, 225, and 226 form the first, second, and third resonators, respectively. This configuration of metal regions 224, 225, and 226 is sometimes referred to as a strip-line structure. The short ends of the resonators connect to ground through vias 204, 205, and 206.

Metal regions 210, 211, and 212 form the first, second, and third inductors, respectively. These are typically referred to as shunt inductors. As shown, metal regions 210, 211, and 212 are generally line-shaped metal regions, with metal regions 210 and 212 exhibiting one 90 degree turn. However, the shape depicted for the loading inductors is only exemplary and any shape of metal region that produced the desired level of inductance may be used. Metal regions 210, 211, and 212 (loading inductors) connect to the open end of metal regions 224, 225, and 226 (resonators) through vias 221, 222, and 223.

Metal regions 210, 211, and 212 (loading inductors) also connect to metal regions 213, 214, and 215. Metal regions 213, 214, and 215 in conjunction with metal region 203 (second floating ground) and metal region 201 (system ground) form the first, second, and third loading capacitors, respectively. These are typically referred to as shunt capacitors. As can be seen from the configuration, by utilizing both the second floating ground and the system ground, the loading capacitors are sandwiched capacitors. By utilizing this configuration, the size of the capacitors, and hence the size of the filter, can be reduced.

Metal regions 217 and 218 in conjunction with metal region 216 form the first and second internal coupling capacitors, respectively. These are parallel plate capacitors. Metal region 217 (first internal coupling capacitor) is connected to the open end of metal region 224 (first resonator) through via 221, while metal region 218 (second internal coupling capacitor) is connected to the open end of metal region 226 (third resonator) through via 223. Metal region 216 (forming part of both the first and second internal coupling capacitor) is directly connected to the open end of metal region 225 (second resonator).

Metal regions 219 and 220 form the direct coupling capacitor. These are also parallel plate capacitors. Metal region 219 is connected to the open end of metal region 226 (third resonator) through via 223, and metal region 220 is connected to the open end of metal region 224 (first resonator) through via 221.

Metal region 227 forms the input terminal is connected directly to the open end of metal region 224 (first resonator). Likewise, metal region 228 forms the output terminal and is connected directly to the open end of metal region 226 (third resonator). In this form, both the input and output terminals are tapped-line I/O terminals.

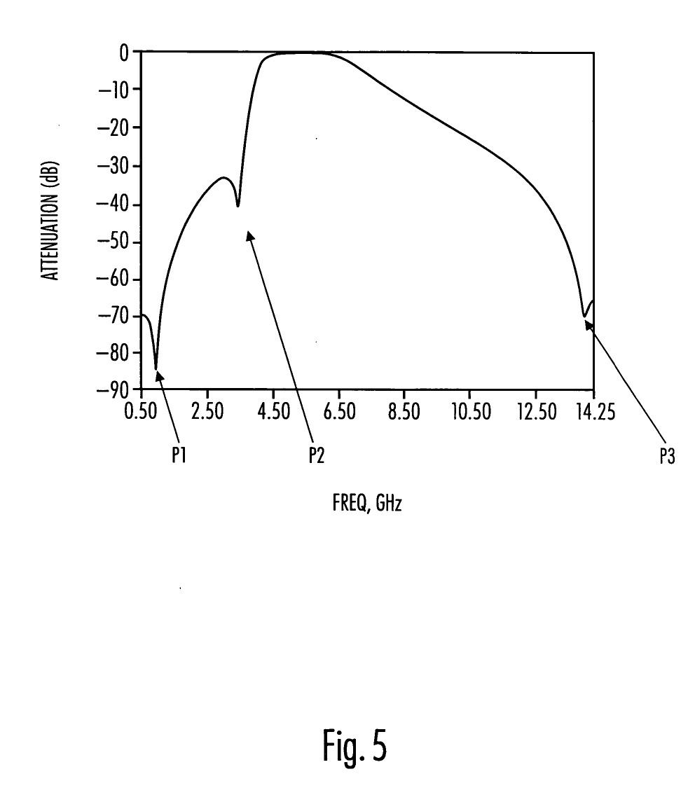

FIG. 5 depicts the frequency response of the circuit depicted in FIG. 3. Through the inclusion of the loading inductors and the direct coupling capacitors, three attenuation poles are achieved in the frequency response. Poles P1 and P2 on the lower-passband side, and pole P3 on the upper-passband side. As can be seen in FIG. 5, the passband (roughly 4.50 to 6.50 GHz) is substantially flat. The frequency performance depicted in FIG. 5 would be generated from a circuit that utilized loading capacitor values of 0.6 pF, loading inductor values of 0.4 nH, internal coupling capacitor values of 0.5 pF, direct coupling capacitor values of 0.15 pF, and resonator lengths and widths of 1100 μm and 100 μm, respectively. Preferably, the height of the LTCC substrate is 500 μm and the dielectric constant (εᵣ) of the ceramic material is 7.5. However, this schematic is applicable for use in bandpass filters with any desired range of frequency response, and as such, the capacitance values, inductance values, resonator lengths, substrate height, and dielectric constant may be adjusted to suit a particular application.

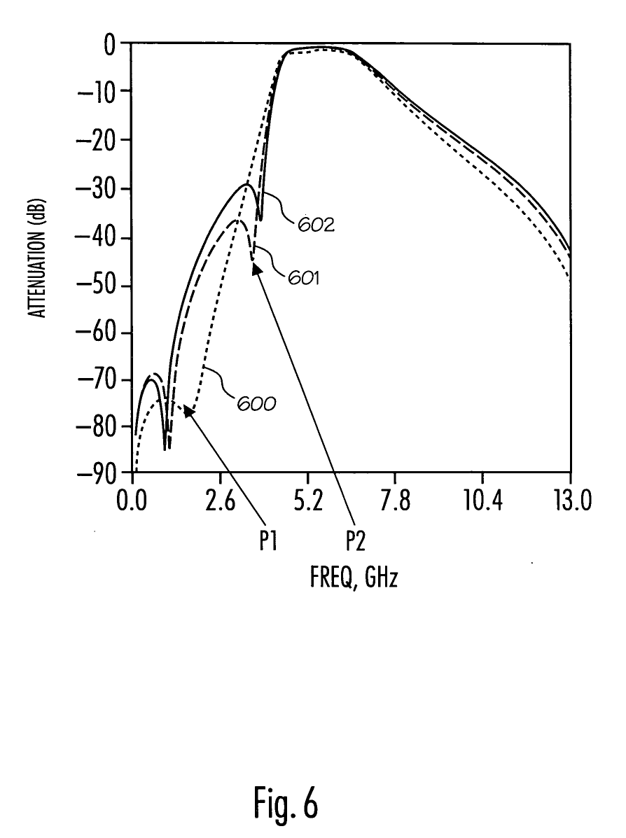

FIG. 6 depicts the frequency response of the circuit depicted in FIG. 3 for varying values of the direct coupling capacitor. The values of the other components remain the same as described above with reference to FIG. 5. As shown in FIG. 6, when the value of the direct coupling capacitor is dropped to zero (effectively no capacitor), frequency response 600 only includes one pole P1 at the lower-passband side. When the direct coupling capacitor has a capacitance of 0.1 pF, frequency response 601 shows two poles (P1 and P2) on the lower-passband side. If the capacitance of the direct coupling capacitor is increased to 0.15 pF, frequency 602 also contains two poles at the lower-passband side. In addition, frequency response 602 exhibits a sharper rolloff for pole P2 than is exhibited by frequency response 601. As such, the frequency responses in FIG. 6 show that a second attenuation pole can be achieved at the lower-passband side by adding a direct coupling capacitor to a combline bandpass filter as shown in FIG. 3. In addition, by changing the capacitance value of the direct coupling capacitor, the frequency response of the bandpass filter can be adjusted to produce a steeper (higher capacitance) or less steep (lower capacitance) rolloff response on the lower-passband side.

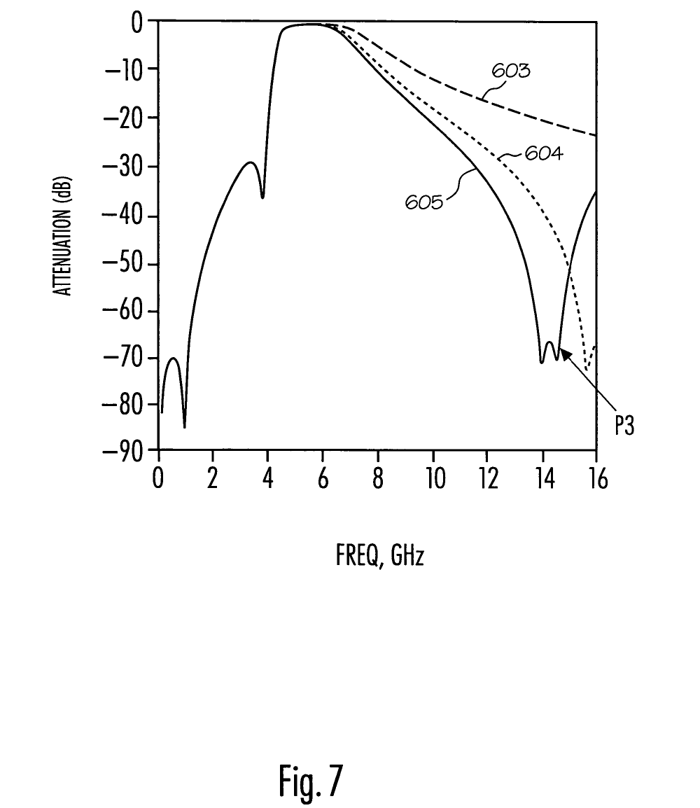

FIG. 7 depicts the frequency response of the circuit depicted in FIG. 3 for varying values of the loading inductors. The values of the other components remain the same as described above with reference to FIG. 5. As shown in FIG. 7, when the value of the loading inductors is dropped to zero (effectively no loading inductors), frequency response 603 includes two poles on the lower-passband side, but no pole on the upper-passband side. In fact, the frequency response on the upper-passband side when there are no loading inductors exhibits a fairly shallow rolloff. When the loading inductors have an inductance of 0.2 nH, frequency response 604 shows an additional pole P3 on the upper-passband side. If the inductance of the loading inductors is increased to 0.3 nH, frequency 605 also contains the additional pole P3 on the upper-passband side. In addition, frequency response 605 exhibits a sharper rolloff for pole P3 than is exhibited by frequency response 604. As such, the frequency responses in FIG. 7 show that a third attenuation pole can be achieved at the upper-passband side by adding loading inductors to a combline bandpass filter as shown in FIG. 3. In addition, by changing the inductance value of the loading inductors, the frequency response of the bandpass filter can be adjusted to produce a steeper (higher inductance) or less steep (lower inductance) rolloff response on the upper-passband side.

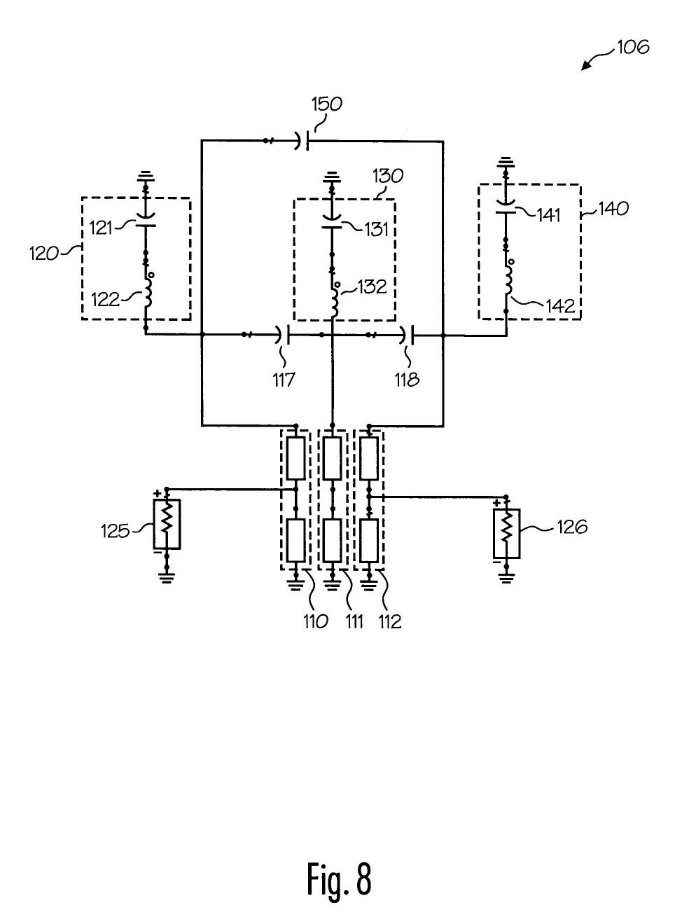

FIG. 8 depicts another embodiment of bandpass filter according to the invention. This embodiment is virtually identical to the filter depicted in FIG. 3 except for the placement of the input and output terminals. As can be seen in FIG. 8, bandpass filter 106 includes input terminal 125 and output terminal 126 that are positioned below the open end of first resonator 110 and third resonator 112 respectively.

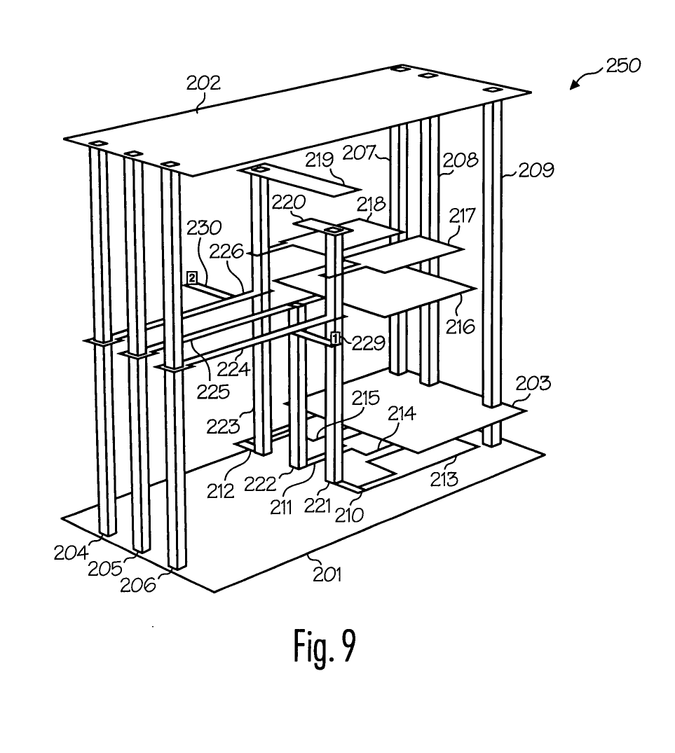

FIG. 9 depicts the physical layout of the bandpass filter of FIG. 9. Bandpass filter layout 250 is identical to bandpass filter layout 200 of FIG. 4 in every respect except for the metal regions forming the input and output terminals. Metal region 229 forms the input terminal and is connected to metal region 224 (first resonator) at a point approximately 200 μm below the open end of metal region 224. Likewise, metal region 230 forms the output terminal and is connected to metal region 226 (third resonator) at a point approximately 200 μm below the open end of metal region 226. The input and output terminals may be positioned at any distance below the open end of the resonators, up to half the length of the resonator.

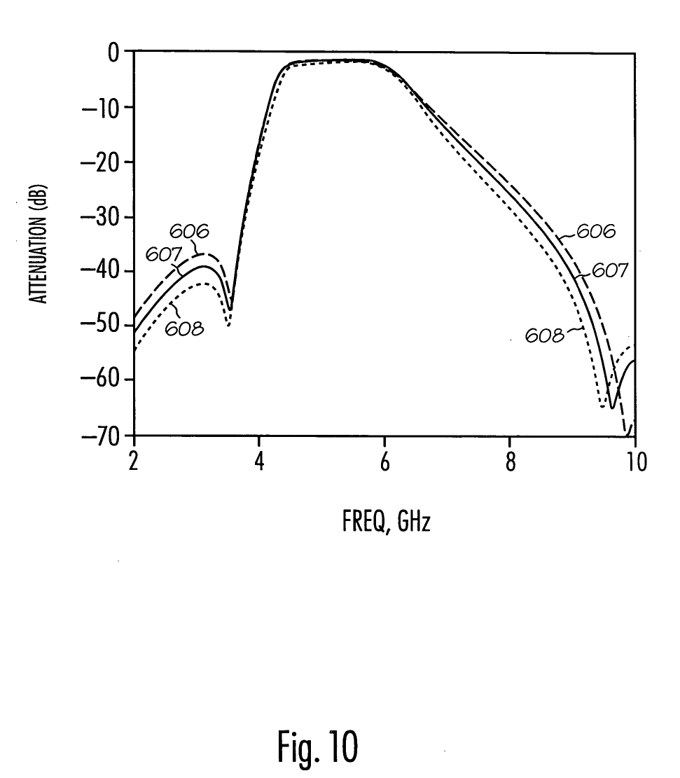

FIG. 10 depicts the frequency response of the circuit depicted in FIGS. 3 and 8 for varying positions of the input and output terminals. The values of the inductive and capacitive components, length of the resonators, height of the substrate, and dielectric constant of the ceramic materials remain the same as described above with reference to FIG. 5. As shown in FIG. 10, the steepness of the rolloff and the attenuation on the upper- and lower-passband sides is increased as the input and output terminals are moved back from the open end of the resonators. Frequency response 606 shows the response when the input and output terminals are at the open end of the resonators, frequency response 607 shows the response when the input and output terminals are set back 200 μm from the open end of the resonators, and frequency response 608 shows the response when the input and output terminals are set back 400 μm from the open end of the resonators.

The bandpass filters described with reference to FIGS. 3 to 10 need not be limited to circuits with only three resonators. Circuits with four or more resonators are also acceptable. All that is required is that there is one LC pair connected in series with each resonator and one internal coupling capacitor between the open ends of each successive resonator. In addition, at least one direct coupling capacitor may be connected between any two resonators that are separated by at least one other resonator. For example, in a circuit that utilizes four resonators, the direct coupling capacitor may be connected between the first and third resonators or between the second and fourth resonators.

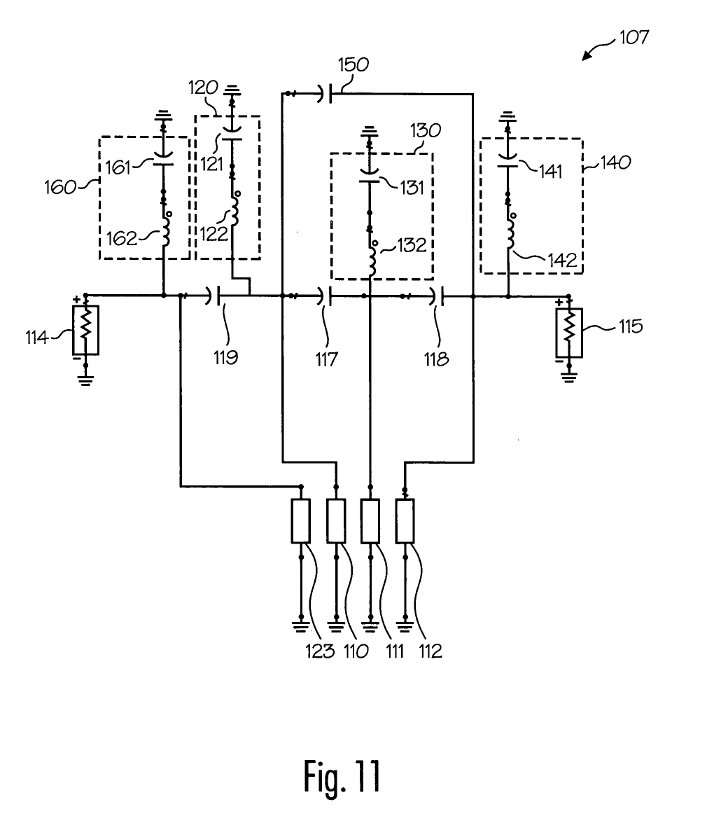

FIG. 11 depicts a schematic of bandpass filter 107 that includes four resonators. This circuit is similar to the circuit depicted in FIG. 3. The four resonator circuit adds a fourth resonator 123, a fourth LC pair 160 connected to the open end of fourth resonator 123, and a third internal coupling capacitor 119 connected between the open end of fourth resonator 123 and first resonator 110. Fourth LC pair 160 includes fourth loading capacitor 161 and fourth loading inductor 162. As shown in FIG. 11, direct coupling capacitor 150 is connected between resonator 110 and resonator 112 (which are separated by resonator 111). As discussed above, it would also be acceptable to connect direct coupling capacitor 150 between resonator 123 and resonator 111 (which are separated by resonator 110).

As discussed above, the addition of a direct coupling capacitor to a combline bandpass filter creates an additional attenuation pole at the lower-passband side in the frequency response of the filter. The addition of loading inductors to a combline bandpass filter creates an attenuation pole at the upper-passband side in the frequency response of the filter. The circuits described thus far have included both the direct coupling capacitor and loading inductors. However, inclusion of both types of these components is not necessary for applications in which improved out-of-band attenuation is only desired for one side of the passband.

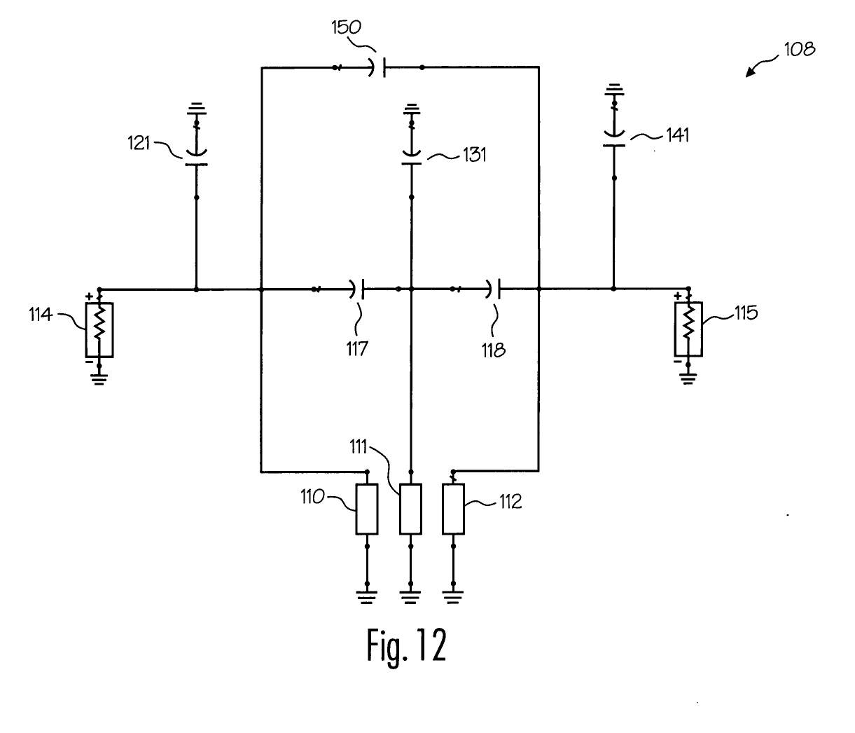

FIG. 12 depicts the schematic for a bandpass filter 108 that includes the direct coupling capacitor 150, but no loading inductors. In this case, first loading capacitor 121, second loading capacitor 131, and third loading capacitor 141 are connected to the open ends of first resonator 110, second resonator 111, and third resonator 112, respectively. First internal coupling capacitor 117 is connected between the open ends of first resonator 110 and second resonator 111 and second internal coupling capacitor 118 is connected between the open ends of second resonator 111 and third resonator 112. Direct coupling capacitor 150 is connected between the open ends of first resonator 110 and third resonator 112. Input terminal 114 is connected to the open end of first resonator 110 and output terminal 115 is connected to the open end of third resonator 112.

As before, more than three resonators may be used so long as there is one loading capacitor connected in series with each resonator and one internal coupling capacitor between the open ends of each successive resonator. In addition, the direct coupling capacitor may be connected between any two resonators that are separated by at least one other resonator.

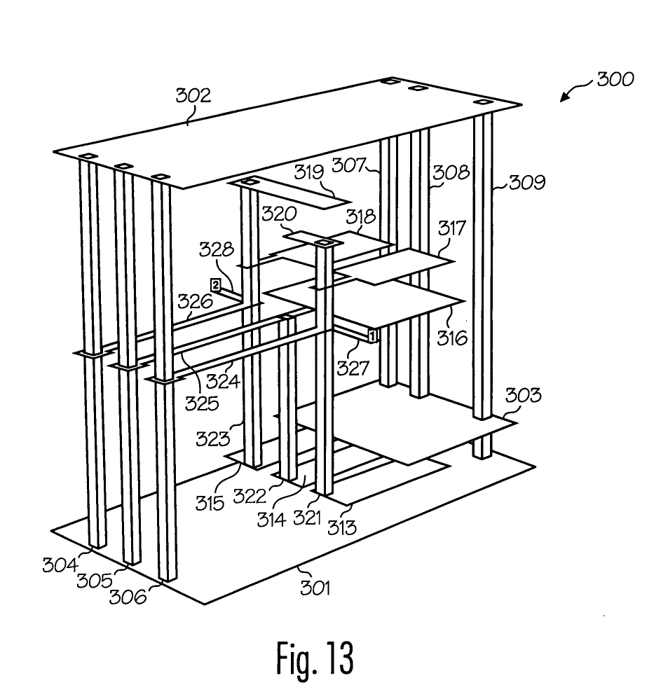

FIG. 13 shows the physical layout of the circuit shown in FIG. 12. Bandpass filter layout 300 includes metal regions 301, 302, and 303 that form the system ground, first floating ground, and second floating ground, respectively. The ground metal regions are connected to each other by vias 304, 305, 306, 307, 308, and 309. Metal regions 324, 325, and 326 form the first, second, and third resonators, respectively. This configuration is often referred to as a strip-line structure. The short end of the resonators is connected to ground through vias 304, 305, and 306, respectively.

Metal regions 313, 314, and 315, in conjunction with metal region 303 (second floating ground) and metal region 301 (system ground), form the first, second, and third loading capacitors, respectively. This configuration is referred to as a sandwiched capacitor. Metal regions 313, 314, and 315 (loading capacitors) connect to metal regions 324, 325, and 326 (resonators) through vias 321, 322, and 323.

Metal regions 317 and 318, in conjunction with metal region 316 form the first and second internal coupling capacitors, respectively. This configuration is referred to as a parallel plate capacitor. Metal region 317 (first internal coupling capacitor) is connected to the open end of metal region 324 (first resonator) through via 321, while metal region 318 (second internal coupling capacitor) is connected to the open end of metal region 326 (third resonator) through via 323. Metal region 316 (forming part of both the first and second internal coupling capacitor) is directly connected to the open end of metal region 325 (second resonator).

Metal regions 319 and 320 form the direct coupling capacitor. This configuration is referred to as a parallel plate capacitor. Metal region 319 is connected to the open end of metal region 326 (third resonator) through via 323, and metal region 320 is connected to the open end of metal region 324 (first resonator) through via 321.

Metal region 327 forms the input terminal is connected directly to the open end of metal region 324 (first resonator). Likewise, metal region 328 forms the output terminal and is connected directly to the open end of metal region 326 (third resonator). In this form, both the input and output terminals are tapped-line I/O terminals.

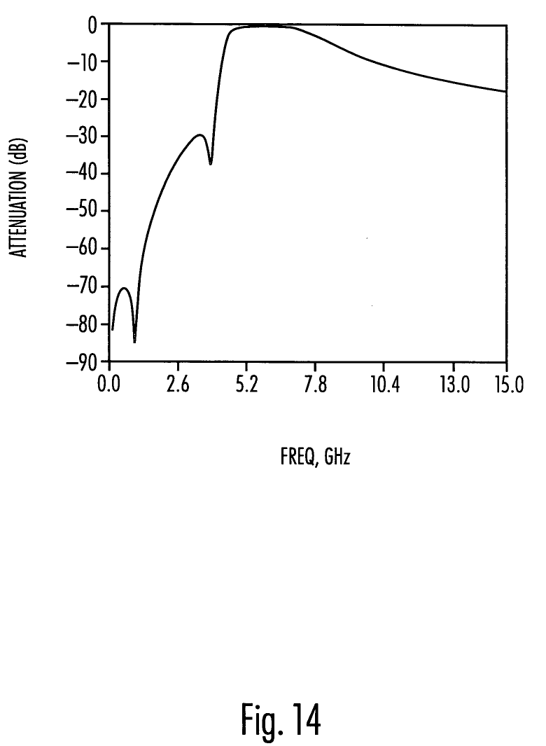

FIG. 14 shows the frequency response of the circuit depicted in FIG. 12. As can be seen, the addition of a direct coupling capacitor to a combline bandpass filter produces two attenuation poles at the lower-passband side of the frequency response.

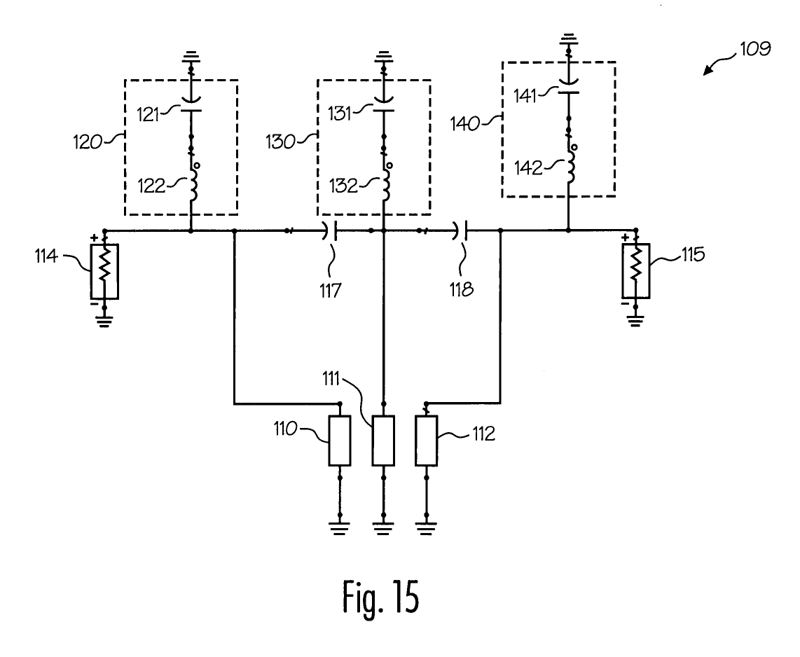

FIG. 15 depicts the schematic for a bandpass filter 109 that includes loading inductors 122, 132, and 142, but no direct coupling capacitor. In this case, first LC pair 120 (including first loading capacitor 121 and first loading inductor 122), second LC pair 130 (including second loading capacitor 131 and second loading inductor 132), and third LC pair 140 (including third loading capacitor 141 and third loading inductor 142) are connected to the open ends of first resonator 110, second resonator 111, and third resonator 112, respectively.

First internal coupling capacitor 117 is connected between the open ends of first resonator 110 and second resonator 111 and second internal coupling capacitor 118 is connected between the open ends of second resonator 111 and third resonator 112. Input terminal 114 is connected to the open end of first resonator 110 and output terminal 115 is connected to the open end of third resonator 112.

As before, more than three resonators may be used so long as there one LC pair connected in series with each resonator and one internal coupling capacitor between the open end of each successive resonator.

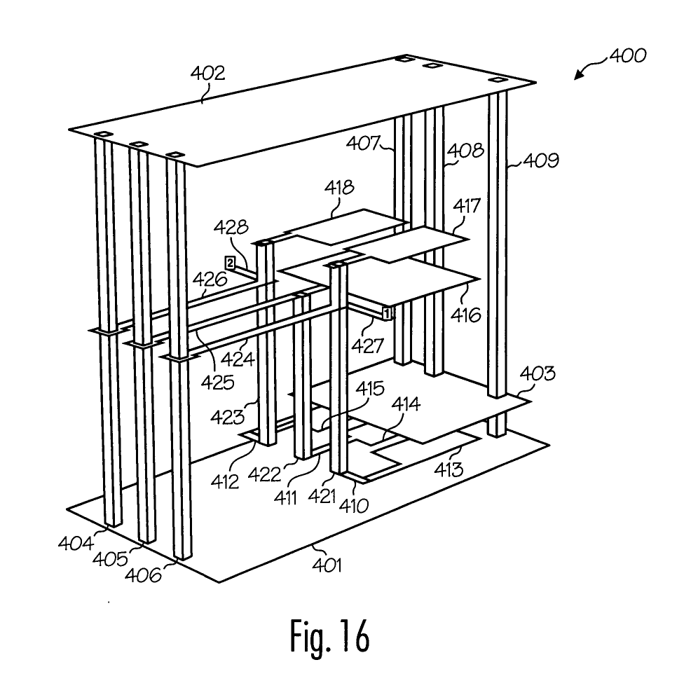

FIG. 16 shows the physical layout of the circuit shown in FIG. 15. Bandpass filter layout 400 includes metal regions 401, 402, and 403 that form the system ground, first floating ground, and second floating ground, respectively. The ground metal regions are connected to each other by vias 404, 405, 406, 407, 408, and 409. Metal regions 424, 425, and 426 form the first, second, and third resonators, respectively. This configuration is referred to as a strip-line structure. The short ends of the resonators connect to ground through vias 404, 405, and 406.

Metal regions 410, 411, and 412 form the first, second, and third inductors, respectively. These are referred to as shunt inductors. As shown, metal regions 410, 411, and 412 are generally line-shaped metal regions, with metal regions 410 and 412 exhibiting one 90 degree turn. However, the shape depicted for the loading inductors is only exemplary and any shape of metal region that produced the desired level of inductance may be used. Metal regions 410, 411, and 412 (loading inductors) connect to the open end of metal regions 424, 425, and 426 (resonators) through vias 421, 422, and 423.

Metal regions 410, 411, and 412 (loading inductors) also connect to metal regions 413, 414, and 415. Metal regions 413, 414, and 415 in conjunction with metal region 403 (second floating ground) and metal region 401 (system ground) form the first, second, and third loading capacitors, respectively. These configurations are referred to as sandwiched capacitors.

Metal regions 417 and 418 in conjunction with metal region 416 form the first and second internal coupling capacitors, respectively. These configurations are referred to as parallel plate capacitors. Metal region 417 (first internal coupling capacitor) is connected to the open end of metal region 424 (first resonator) through via 421, while metal region 418 (second internal coupling capacitor) is connected to the open end of metal region 426 (third resonator) through via 423. Metal region 416 (forming part of both the first and second internal coupling capacitor) is directly connected to the open end of metal region 425 (second resonator).

Metal region 427 forms the input terminal is connected directly to the open end of metal region 424 (first resonator). Likewise, metal region 428 forms the output terminal and is connected directly to the open end of metal region 426 (third resonator). In this form, both the input and output terminals are tapped-line I/O terminals.

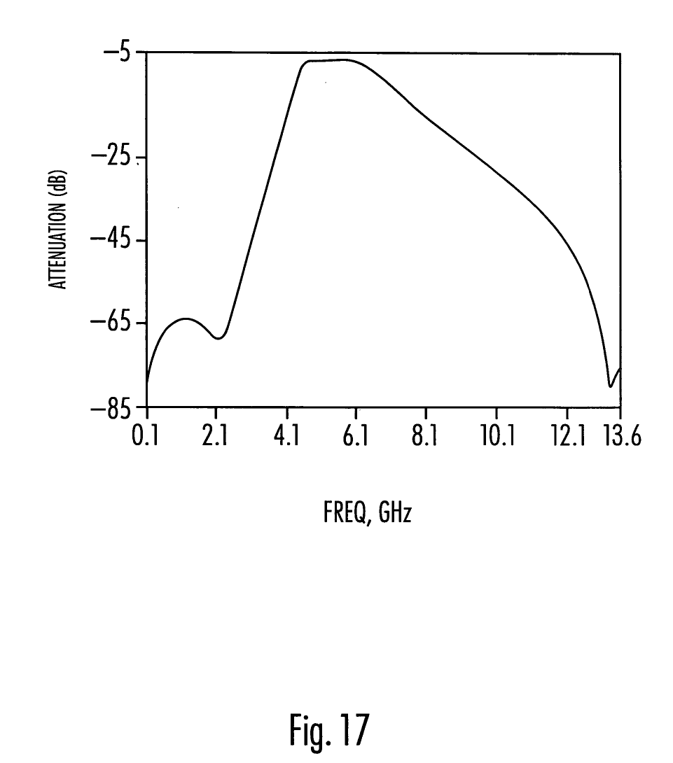

FIG. 17 shows the frequency response of the circuit depicted in FIG. 15. As can be seen, the addition of loading inductors to a combline bandpass filter produces an attenuation pole at the upper-passband side of the frequency response.

Other embodiments of the invention will be apparent to those skilled in the art from consideration of the specification and embodiments disclosed herein. Thus, the specification and examples are exemplary only, with the true scope and spirit of the invention set forth in the following claims and legal equivalents thereof.

What is claimed is:

1. A bandpass filter comprising:
a combline bandpass filter including tapped-line input and output terminals and at least three resonators; and
a direct coupling capacitor connected between any two of the at least three resonators that are separated by at least one other resonator.

2. The bandpass filter according to claim 1,
wherein the combline bandpass filter comprises,
a first resonator, a second resonator, and a third resonator, each resonator having an open end and a short end, each of the resonators short ends being connected to ground;
a first loading capacitor connected between the open end of the first resonator and ground;
a second loading capacitor connected between the open end of the second resonator and ground;
a third loading capacitor connected between the open end of the third resonator and ground;
a first internal coupling capacitor connected between the open end of the first resonator and the open end of the second resonator; and
a second internal coupling capacitor connected between the open end of the second resonator and the open end of the third resonator, and
wherein the direct coupling capacitor is connected between the open end of the first resonator and the open end of the third resonator.

3. The bandpass filter according to claim 2, wherein each of the resonators is a transverse electromagnetic quarter-wave resonator.

4. The bandpass filter according to claim 2, wherein the tapped-line input terminal is connected to the open end of the first resonator and the tapped-line output terminal is connected to the open end of the third resonator.

5. The bandpass filter according to claim 2, wherein the tapped-line input terminal is connected to the first resonator at a position recessed from the open end of the first resonator and the tapped-line output terminal is connected to the third resonator at a position recessed from the open end of the second resonator.

6. The bandpass filter according to claim 2, wherein the bandpass filter has a multilayer structure.

7. The bandpass filter according to claim 6, wherein the multilayer structure is a low temperature co-fired ceramic multilayer structure.

8. A bandpass filter comprising:
a combline bandpass filter including tapped-line input and output terminals, at least three resonators, and a loading capacitor for each resonator; and
a plurality of loading inductors, each loading inductor being connected between one of the resonators and its respective loading capacitor.

9. The bandpass filter according to claim 8,
wherein the combline bandpass filter comprises,
a first resonator, a second resonator, and a third resonator, each resonator having an open end and a short end, each of the resonators short ends being connected to ground,
a first internal coupling capacitor connected between the open end of the first resonator and the open end of the second resonator;
a second internal coupling capacitor connected between the open end of the second resonator and the open end of the third resonator; and
a first, second and third loading capacitor,
wherein the plurality of loading inductors includes a first, second, and third loading inductor,
the first loading inductor and the first loading capacitor forming a first LC pair, the first LC pair being connected between the open end of the first resonator and ground;
the second loading inductor and the second loading capacitor forming a second LC pair, the second LC pair being connected between the open end of the second resonator and ground; and
the third loading inductor and the third loading capacitor forming a third LC pair, the third LC pair being connected between the open end of the third resonator and ground.

10. The bandpass filter according to claim 9, wherein each of the resonators is a transverse electromagnetic quarter-wave resonator.

11. The bandpass filter according to claim 9, wherein the tapped-line input terminal is connected to the open end of the first resonator and the tapped-line output terminal is connected to the open end of the third resonator.

12. The bandpass filter according to claim 9, wherein the tapped-line input terminal is connected to the first resonator at a position recessed from the open end of the first resonator and the tapped-line output terminal is connected to the third resonator at a position recessed from the open end of the second resonator.

13. The bandpass filter according to claim 9, wherein the bandpass filter has a multilayer structure.

14. The bandpass filter according to claim 13, wherein the multilayer structure is a low temperature co-fired ceramic multilayer structure.

15. A bandpass filter comprising:
a combline bandpass filter including tapped-line input and output terminals, at least three resonators, and a loading capacitor for each resonator;
a plurality of loading inductors, each loading inductor being connected between one of the resonators and its respective loading capacitor; and
a direct coupling capacitor connected between any two of the at least three resonators that are separated by at least one other resonator.

16. The bandpass filter according to claim 15,
wherein the combline bandpass filter comprises,
a first resonator, a second resonator, and a third resonator, each resonator having an open end and a short end, each of the resonators short ends being connected to ground,
a first internal coupling capacitor connected between the open end of the first resonator and the open end of the second resonator;
a second internal coupling capacitor connected between the open end of the second resonator and the open end of the third resonator; and
a first, second and third loading capacitor, and
wherein the plurality of loading inductors includes a first, second, and third loading inductor,
the first loading inductor and the first loading capacitor forming a first LC pair, the first LC pair being connected between the open end of the first resonator and ground;
the second loading inductor and the second loading capacitor forming a second LC pair, the second LC pair being connected between the open end of the second resonator and ground; and
the third loading inductor and the third loading capacitor forming a third LC pair, the third LC pair being connected between the open end of the third resonator and ground; and
wherein the direct coupling capacitor is connected between the open end of the first resonator and the open end of the third resonator.

17. The bandpass filter according to claim 16, wherein each of the resonators is a transverse electromagnetic quarter-wave resonator.

18. The bandpass filter according to claim 16, wherein the tapped-line input terminal is connected to the open end of the first resonator and the tapped-line output terminal is connected to the open end of the third resonator.

19. The bandpass filter according to claim 16, wherein the tapped-line input terminal is connected to the first resonator at a position recessed from the open end of the first resonator and the tapped-line output terminal is connected to the third resonator at a position recessed from the open end of the second resonator.

20. The bandpass filter according to claim 16, wherein the bandpass filter has a multilayer structure.

21. The bandpass filter according to claim 20, wherein the multilayer structure is a low temperature co-fired ceramic multilayer structure.

22. The bandpass filter according to claim 15,
wherein the combline bandpass filter comprises
a first resonator, a second resonator, a third resonator, and a fourth resonator each resonator having an open end and a short end, each of the resonators short ends being connected to ground;
a first internal coupling capacitor connected between the open end of the first resonator and the open end of the second resonator;
a second internal coupling capacitor connected between the open end of the second resonator and the open end of the third resonator;
a third internal coupling capacitor connected between the open end of the third resonator and the open end of the fourth resonator; and
a first, second, third, and fourth loading capacitor; and
wherein the plurality of loading inductors includes a first, second, third, and fourth loading inductor,
the first loading inductor and the first loading capacitor forming a first LC pair, the first LC pair being connected between the open end of the first resonator and ground;
the second loading inductor and the second loading capacitor forming a second LC pair, the second LC pair being connected between the open end of the second resonator and ground;
the third loading inductor and the third loading capacitor forming a third LC pair, the third LC pair being connected between the open end of the third resonator and ground;
the fourth loading inductor and the fourth loading capacitor forming a fourth LC pair, the fourth LC pair being connected between the open end of the fourth resonator and ground; and
wherein the direct coupling capacitor is connected between the open end of the first resonator and the open end of the third resonator or the direct coupling capacitor is connected between the open end of the second resonator and the open end of the fourth resonator.

23. A method of creating and controlling an additional lower-passband side attenuation pole in the frequency response of a combline bandpass filter that includes at least three resonators, the method comprising the step of:
connecting a direct coupling capacitor between any two of the at least three resonators that are separated by at least one other resonator.

24. The method according to claim 23, wherein the bandpass filter exhibits a nominal frequency response, with a nominal lower-passband side attenuation and rolloff, when a direct coupling capacitor with a nominal value is connected, and wherein the lower-passband side attenuation is increased by increasing the value of the direct coupling capacitor and the lower-passband side rolloff is made steeper by increasing the value of the direct coupling capacitor.

25. The method according to claim 23, wherein the bandpass filter exhibits a nominal frequency response, with a nominal lower-passband side attenuation and rolloff, when a direct coupling capacitor with a nominal value is connected, and wherein the lower-passband side attenuation is decreased by decreasing the value of the direct coupling capacitor and the lower-passband side rolloff is made less steep by decreasing the value of the direct coupling capacitor.

26. A method of creating and controlling an upper-passband side attenuation pole in the frequency response of a combline bandpass filter that includes at least three resonators and a loading capacitor for each resonator, the method comprising the step of:
connecting each of a plurality of loading inductors between one of the resonators and its respective loading capacitor.

27. The method according to claim 26, wherein the bandpass filter exhibits a nominal frequency response, with a nominal upper-passband side attenuation and rolloff, when loading inductors with nominal values are connected, and wherein the upper-passband side attenuation is increased by increasing the value of the loading inductors and the upper-passband side rolloff is made steeper by increasing the value of the loading inductors.

28. The method according to claim 26, wherein the bandpass filter exhibits a nominal frequency response, with a nominal upper-passband side attenuation and rolloff, when loading inductors with nominal values are connected, and wherein the upper-passband side attenuation is decreased by decreasing the value of the loading inductors and the upper-passband side rolloff is made less steep by decreasing the value of the loading inductors.

29. A method of creating and controlling an additional lower-passband side attenuation pole and an upper-passband side attenuation pole in the frequency response of a combline band pass filter that includes at least three resonators and a loading capacitor for each resonator, the method comprising the steps of:
connecting a direct coupling capacitor between any two of the at least three resonators that are separated by at least one other resonator; and
connecting each of a plurality of loading inductors between one of the resonators and its respective loading capacitor.

30. The method according to claim 29, wherein the bandpass filter exhibits a nominal frequency response, with a nominal lower-passband side attenuation and rolloff, when a direct coupling capacitor with a nominal value is connected, and wherein the lower-passband side attenuation is increased by increasing the value of the direct coupling capacitor and the lower-passband side rolloff is made steeper by increasing the value of the direct coupling capacitor.

31. The method according to claim 29, wherein the bandpass filter exhibits a nominal frequency response, with a nominal lower-passband side attenuation and rolloff, when a direct coupling capacitor with a nominal value is connected, and wherein the lower-passband side attenuation is decreased by decreasing the value of the direct coupling capacitor and the lower-passband side rolloff is made less steep by decreasing the value of the direct coupling capacitor.

32. The method according to claim 29, wherein the bandpass filter exhibits a nominal frequency response, with a nominal upper-passband side attenuation and rolloff, when loading inductors with nominal values are connected, and wherein the upper-passband side attenuation is increased by increasing the value of the loading inductors and the upper-passband side rolloff is made steeper by increasing the value of the loading inductors.

33. The method according to claim 29, wherein the bandpass filter exhibits a nominal frequency response, with a nominal upper-passband side attenuation and rolloff, when loading inductors with nominal values are connected, and wherein the upper-passband side attenuation is decreased by decreasing the value of the loading inductors and the upper-passband side rolloff is made less steep by decreasing the value of the loading inductors.
